(19) United States
(12) Patent Application Publication
(10) Pub. No.: US 2008/0117122 A1
(43) Pub. Date: May 22, 2008

(54) PLASMA DISPLAY AND DRIVING METHOD THEREOF

(76) Inventors: Joon-Yeon Kim, Yongin-si (KR); Hak-Cheol Yang, Yongin-si (KR)

Correspondence Address: CHRISTIE, PARKER & HALE, LLP, PO BOX 7068, PASADENA, CA, 91109-7068, US

(21) Appl. No.: 11/696,640

(22) Filed: Apr. 4, 2007

(30) Foreign Application Priority Data
Nov. 20, 2006 (KR) 10-2006-0114611

(51) Int. Cl. G09G 3/28

(52) U.S. Cl. 345/60

(57) ABSTRACT

A method for driving a plasma display device (PDP) during subfields of a frame including a first subfield. The PDP includes scan lines corresponding to first and second display regions, address lines crossing the scan lines, and first and second discharge cells respectively defined by the first display regions and the address lines and by the second display regions and the address lines. The method includes: selecting a first non-light emitting cell from among first light emitting cells of the first discharge cells during a first address period of the first subfield; selecting a second non-light emitting cell from among second light emitting cells of the second discharge cells during a second address period of the first subfield; and sustain-discharging the first and second light emitting cells during a first period previous to the first address period and a second period previous to the second address period, respectively.

### CROSS-REFERENCE TO RELATED APPLICATION

This application claims priority to and the benefit of Korean Patent Application No. 10-2006-0114611, filed in the Korean Intellectual Property Office on Nov. 20, 2006, the entire content of which is incorporated herein by reference.

### BACKGROUND OF THE INVENTION

(a) Field of the Invention

The present invention relates to a plasma display device and a driving method thereof.

(b) Description of the Related Art

A plasma display device is a flat panel display that uses plasma generated by a gas discharge process to display characters or images. It includes a plurality of discharge cells.

The plasma display device is driven during frames of time. One frame of the plasma display device is divided into a plurality of subfields having a corresponding brightness weight. In an address period of each subfield, turn-on discharge cells (i.e., on-cells) and turn-off discharge cells (i.e., off-cells) are selected among the discharge cells, and the on-cells are sustain discharged corresponding to the brightness weight of the corresponding subfield during a sustain period to display an image.

During the address period, a plurality of display lines are sequentially scanned to select the on-cells and the off-cells. Therefore, a number of scan circuits respectively corresponding to the display lines are required to sequentially scan the plurality of display lines. Accordingly, manufacturing costs of the plasma display device may be increased.

The above information disclosed in this Background section is only for enhancement of understanding of the background of the invention, and therefore it may contain information that does not form the prior art that is already known in this country to a person of ordinary skill in the art.

### SUMMARY OF THE INVENTION

An aspect of the present invention provides a plasma display device using a reduced number of scan circuits, and a driving method thereof.

A method according to an exemplary embodiment of the present invention is for driving a plasma display device during a plurality of subfields of a frame. The plasma display device includes a plurality of scan lines and a plurality of address lines crossing the scan lines, the scan lines corresponding to first display regions and second display regions, and further includes a plurality of first discharge cells defined by the first display regions and the address lines, and a plurality of second discharge cells defined by the second display regions and the address lines. The method includes: selecting a first non-light emitting cell from among a plurality of first light emitting cells of the plurality of first discharge cells during a first address period of a first subfield among the plurality of subfields; selecting a second non-light emitting cell from among a plurality of second light emitting cells of the plurality of second discharge cells during a second address period of the first subfield; sustain-discharging only the plurality of first light emitting cells during a first period immediately previous to the first address period; and sustain-discharging only the plurality of second light emitting cells during a second period immediately previous to the second address period.

A method according to another exemplary embodiment of the present invention is for driving a plasma display device during a plurality of subfields of a frame. The plasma display device includes a plurality of scan electrodes forming a plurality of scan lines, a plurality of sustain electrodes corresponding to the plurality of scan electrodes, a plurality of display regions defined by the scan electrodes and the sustain electrodes, a plurality of address electrodes crossing the display regions, and a plurality of discharge cells formed at crossing regions of the display regions and the address electrodes. The method includes: during a first period of a first sustain period of a first subfield among the plurality of subfields, applying a first voltage and a second voltage higher than the first voltage respectively to a sustain electrode of a first sustain electrode group of the plurality of sustain electrodes and a sustain electrode of a second sustain electrode group of the plurality of sustain electrodes, and applying a third voltage higher than the first voltage to the plurality of scan electrodes; during a first address period of a second subfield among the plurality of subfields following the first period of the first sustain period, sequentially applying a first scan pulse to the plurality of scan lines concurrently with applying a fourth voltage to the sustain electrodes of the first and second sustain electrode groups; during a second period of a second sustain period of the second subfield following the first address period, applying the second voltage and the first voltage respectively to the sustain electrodes of the first sustain electrode group and the sustain electrodes of the second sustain electrode group, and applying the third voltage to the plurality of scan electrodes; and, during a second address period of the second subfield following the second period of the second sustain period, sequentially applying a second scan pulse to the plurality of scan lines concurrently with applying the fourth voltage to the sustain electrodes of the first and second sustain electrode groups.

A plasma display device according to another exemplary embodiment of the present invention includes a plasma display panel (PDP) and a driver. The PDP includes a plurality of scan lines corresponding to a plurality of first display regions and a plurality of second display regions, a plurality of address lines crossing the scan lines, and a plurality of discharge cells defined by the first display regions, the second display regions, and the plurality of address lines. The driver is adapted to: in a first period of a first sustain period of a first subfield of subfields of a frame, sustain-discharge a plurality of first light emitting cells defined by the plurality of first display regions; in a first address period of a second subfield of the subfields following the first period of the first sustain period, select non-light emitting cells from the plurality of first light emitting cells; in a second period of a second sustain period of the second subfield following the first address period, sustain-discharge a plurality of second light emitting cells defined by the plurality of second display regions; and, in a second address period of the second subfield following the second period of the second sustain period, select non-light emitting cells from the plurality of second light emitting cells.

### BRIEF DESCRIPTION OF THE DRAWINGS

FIG. 1 shows a plasma display device according to an exemplary embodiment of the present invention.

FIG. 2 and FIG. 3 respectively show an electrode arrangement diagram according to first and second exemplary embodiments of the present invention.

FIG. 4 shows a driving method of a plasma display device according to exemplary embodiments of the present invention.

FIG. 5 shows a driving waveform of first to third subfields of the plasma display device.

FIG. 6 shows a driving waveform of a fourth subfield of the plasma display device.

FIG. 7 shows a driving waveform of a fifth subfield of the plasma display device.

FIG. 8 shows a discharge cell defined by a first display region, a second display region, and an address electrode.

### DETAILED DESCRIPTION

An exemplary embodiment of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification. Throughout this specification and the claims which follow, when it is described that a first element is coupled to a second element, the first element may be directly coupled to the second element or electrically coupled to the second element through a third element.

Wall charges mentioned in the following description mean charges formed and accumulated on a wall (e.g., a dielectric layer) close to an electrode of a discharge cell. A wall charge will be described as being “formed” or “accumulated” on the electrodes, although the wall charges do not actually touch the electrodes. Further, a wall voltage means a potential difference formed on the wall of the discharge cell by the wall charges, and a wall voltage of an electrode means a potential created by the wall charges formed on the electrode.

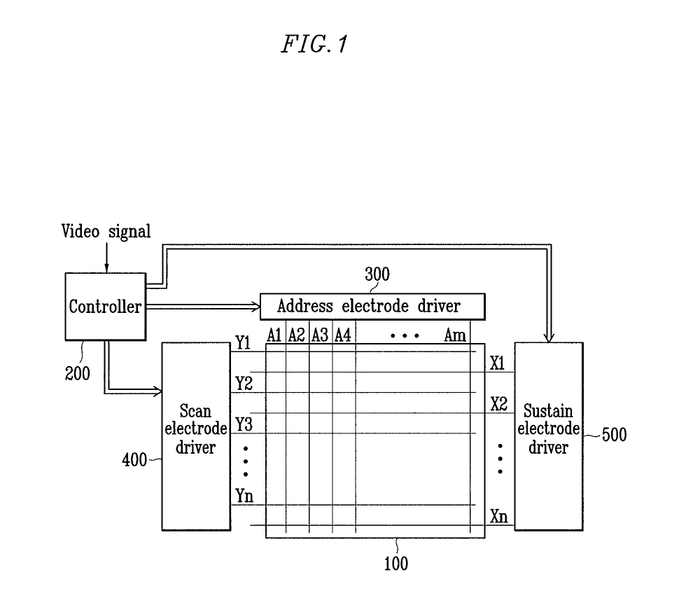

A plasma display device according to an exemplary embodiment of the present invention will now be described in more detail with reference to FIGS. 1, 2, and 3.

FIG. 1 shows a plasma display device according to an exemplary embodiment of the present invention.

As shown in FIG. 1, the plasma display device includes a plasma display panel (PDP) 100, a controller 200, an address electrode driver 300, a scan electrode driver 400, and a sustain electrode driver 500.

The PDP 100 includes a plurality of address electrodes A1 to Am extending in a column direction, and a plurality of sustain electrodes X1 to Xn and a plurality of scan electrodes Y1 to Yn extending in a row direction in pairs. Hereinafter, each of the address electrodes, the sustain electrodes, and the scan electrodes will be respectively referred to as an A electrode, an X electrode, and a Y electrode.

The controller 200 receives external video signals and outputs an A electrode driving control signal, an X electrode driving control signal, and a Y electrode driving control signal. The PDP is driven during frames of time. The controller 200 divides each frame into a plurality of subfields respectively having a brightness weight. In addition, the controller 200 outputs a control signal for dividing the plurality of X electrodes into a first group and a second group. The first group includes even-numbered X electrodes (or “X_even”), and the second group includes odd-numbered X electrodes (or “X_odd”).

The address electrode driver 300 receives the A electrode driving control signal from the controller 200, and applies driving voltages to the A electrodes A1 to Am.

The scan electrode driver 400 receives the Y electrode driving control signal from the controller 200, and applies driving voltages to the Y electrodes.

The sustain electrode driver 500 receives the X electrode driving control signal from the controller 200, and applies driving voltages to the X electrodes.

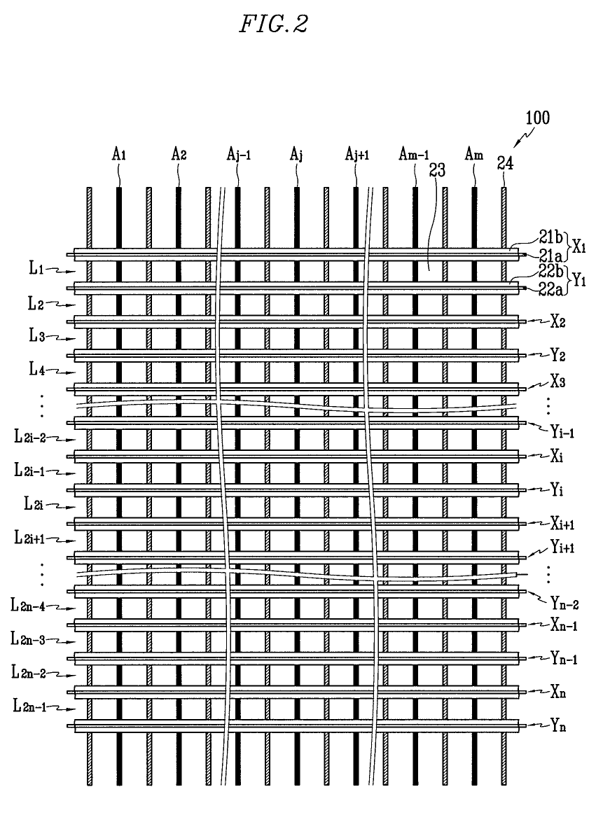

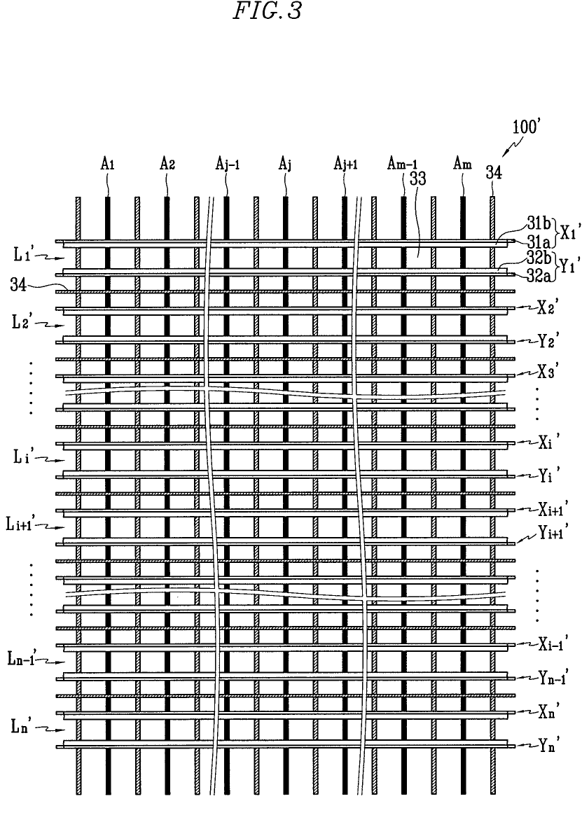

FIG. 2 and FIG. 3 respectively show an electrode arrangement of the PDP shown in FIG. 1 according to first and second exemplary embodiments of the present invention.

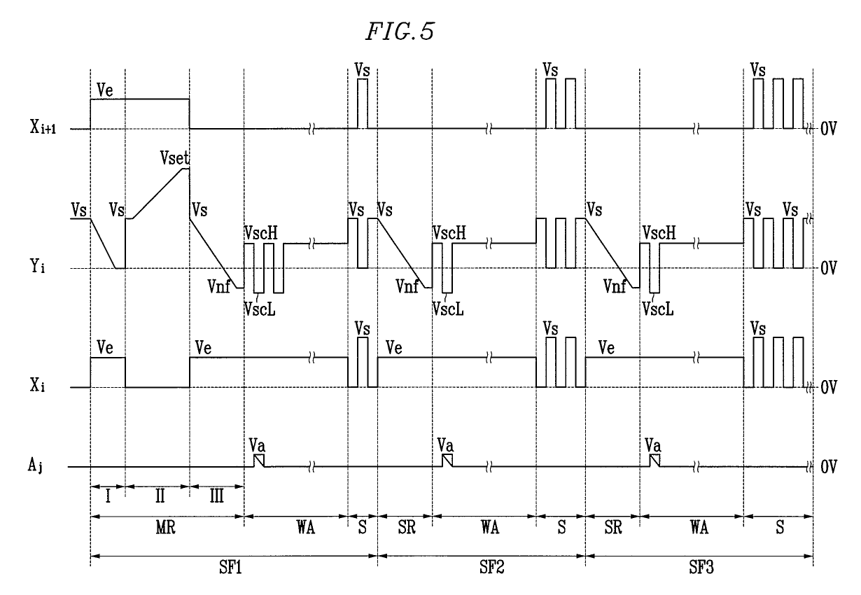

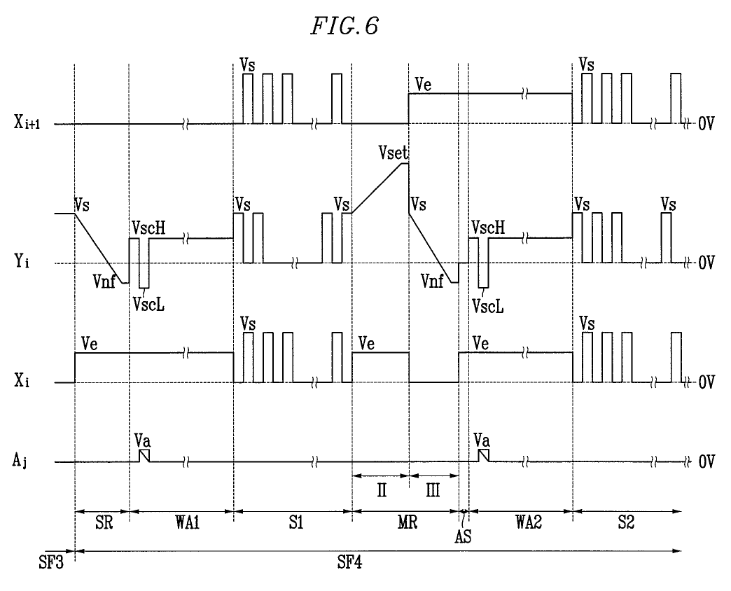

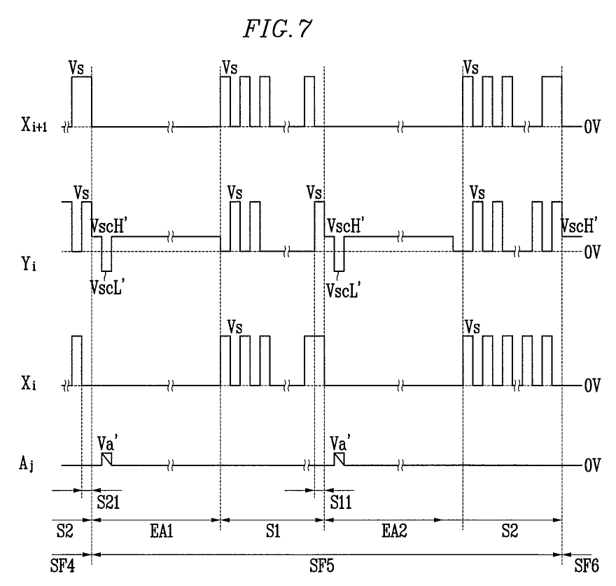

With reference to FIG. 2, in one embodiment of the PDP 100, the A electrodes A1 to Am are formed on one substrate, and the X electrodes X1 to Xn and the Y electrodes Y1 to Yn are formed on another substrate, such that the two substrates face each other. The X electrodes X1 to Xn are formed respectively corresponding to the Y electrodes Y1 to Yn. Here, the Y electrodes Y1 to Yn form scan lines to which a scan voltage (see, for example, a VscL voltage in FIG. 5 and FIG. 6, and a VscL′ voltage in FIG. 7) is applied during an address period, and A electrodes A1 to Am form address lines to which an address voltage (see, for example, a Va voltage in FIG. 5 and FIG. 6, and a Va′ voltage in FIG. 7) is applied during the address period. As shown in FIG. 2, display regions (or display lines) L1 to L(2n-1) for displaying an image are defined by the Y electrodes Y1 to Yn and the X electrodes X1 to Xn, and include first display regions and second display regions. Here, one Y electrode defines two display regions. For example, a first scan electrode Y1 and a first sustain electrode X1 define one display region, and the first scan electrode Y1 and a second sustain electrode X2 define another display region. Therefore, the display regions L1 to L(2n-1) can include a plurality of first display regions respectively defined by odd-numbered X electrodes X1, X3, . . . , X(n-1) of the first group and a plurality of second display regions respectively defined by even-numbered X electrodes X2, X4, . . . Xn of the second group. For purposes of convenience, it is assumed in FIGS. 2 and 3 that ‘i’ is an odd number and that ‘n’ is an even number. A scan line is a line for transmitting a scan pulse, and the scan electrodes Y1 to Yn respectively correspond to a plurality of scan lines which are respectively coupled to a plurality of scan circuits. In addition, each of the scan electrodes Y1 to Yn may be conceptually divided into one portion adjacent to the first display region (hereinafter referred to as “an odd portion”) and another portion adjacent to the second display region (hereinafter referred to as “an even portion”). That is, the odd portions of the Y electrodes Y1 to Yn are adjacent to the odd-numbered X electrodes, and the even portions of the Y electrodes Y1 to Yn are adjacent to the even-numbered X electrodes.

Discharge spaces formed at crossing regions of the display regions L1 to L(2n-1) and the A electrodes A1 to Am respectively define discharge cells (or cells) 23. The discharge cells 23 are partitioned in the row direction by barrier ribs 24. The barrier ribs 24 extend in the column direction, and each barrier rib is provided between two adjacent A electrodes. The X electrodes X1 to Xn and the Y electrodes Y1 to Yn extend in the row direction (i.e., x-axis direction). Each of the X electrodes X1 to Xn includes a bus electrode 21a and a transparent electrode 21b, and each of the Y electrodes Y1 to Yn includes a bus electrode 22a and a transparent electrode 22b. The transparent electrodes 21b and 22b are respectively connected with the bus electrodes 21a and 22a. Here, a portion adjacent to the odd-numbered X electrode in the transparent electrode 22b may correspond to the odd portion, and a portion adjacent to the even-numbered X electrode in the transparent electrode 22b may correspond to the even portion. In one embodiment, the width (or dimension) along the column direction of the transparent electrode 21b or 22b may be wider than that of the bus electrode 21a or 22a. In one embodiment, each of the X electrodes and the Y electrodes may be formed by a wide bus electrode without the transparent electrodes, or formed by the transparent electrode with the bus electrode. In one embodiment, additional barrier ribs may be formed on the bus electrodes 21a and 22a such that the discharge cells 23 can be partitioned in the column direction.

As described, according to the first exemplary embodiment of the present invention, two neighboring display regions share one X electrode or one Y electrode, and, therefore, the shared X electrode or the shared Y electrode participate in discharge of the discharge cells 23 defined by the two neighboring display regions. Compared to a configuration in which only one display region is defined by a pair of an X electrode and a Y electrode, the number of X electrodes and the number of Y electrodes can be reduced by half according to the first exemplary embodiment of the present invention while keeping the same number of display regions. For example, to drive 512 display regions in such a configuration, 512 X electrodes and 512 Y electrodes are required. However, in the PDP according to the first exemplary embodiment of the present invention, the number of the X or Y electrodes may be about half of 512, i.e., 256.

FIG. 3 shows another exemplary embodiment of an electrode arrangement of a PDP 100′. The PDP 100′ may be used in the plasma display device of FIG. 1 instead of the PDP 100. As shown in FIG. 3, the electrode arrangement of the PDP 100′ is similar to that of the first exemplary embodiment of the present invention except that only one display region in the PDP 100′ is formed by one Y electrode or one X electrode. That is, the barrier ribs 34 are formed in a parallel direction (i.e., y-axis direction) with respect to the A electrodes and in a direction crossing the A electrodes A1 to Am. The display region Li′ is defined by the X electrode Xi′ and the Y electrode Yi′ which is adjacent to the X electrode Xi′ at only one side. Therefore, each of a plurality of first display regions L1′, . . . , Li′, . . . , L(n-1)′ is defined by a corresponding one of the odd-numbered X electrodes X1′, . . . , Xi′, . . . , X(n-1)′ and a corresponding one of the odd-numbered Y electrodes Y1′, . . . , Yi′, . . . , Y(n-1)′, and each of a plurality of second display regions L2′, . . . , L(i+1)′, . . . , Ln′ is defined by a corresponding one of the even-numbered X electrodes X2′, . . . , X(i+1)′, . . . , Xn′ and a corresponding one of the even-numbered Y electrodes Y2 . . . . . , Y(i+1)′, . . . , Yn′. In another embodiment, each of a plurality of first display regions may be defined by a corresponding one of the odd-numbered X electrodes and a corresponding one of the even-numbered Y electrodes, and each of a plurality of second display regions is defined by a corresponding one of the even-numbered X electrodes and a corresponding one of the odd-numbered Y electrodes. In addition, transparent electrodes 31b and 32b are formed differently from those of FIG. 2, and are respectively coupled to bus electrodes 31a and 32a.

Furthermore, each of a plurality of scan lines corresponds to a pair of scan electrodes. That is, each scan line includes one of the odd-numbered Y electrodes and one of the even-numbered Y electrodes. Therefore, a scan pulse is concurrently applied to two scan electrodes for an address period. As a result, the number of scan circuits coupled to the scan lines may be reduced by about half.

A method for driving the plasma display device having the PDPs 100 and 100′ according to the first and second exemplary embodiments of the present invention, respectively, will now be described in more detail. For better understanding and ease of description, the method for driving the plasma display device will be described with reference to the PDP 100 of FIG. 2. The method for driving the PDP 100′ shown in FIG. 3 is similar to that according to the first exemplary embodiment of the present invention except that the scan pulse is concurrently applied to one of the odd-numbered Y electrodes and one of the even-numbered Y electrodes both corresponding to the one scan line.

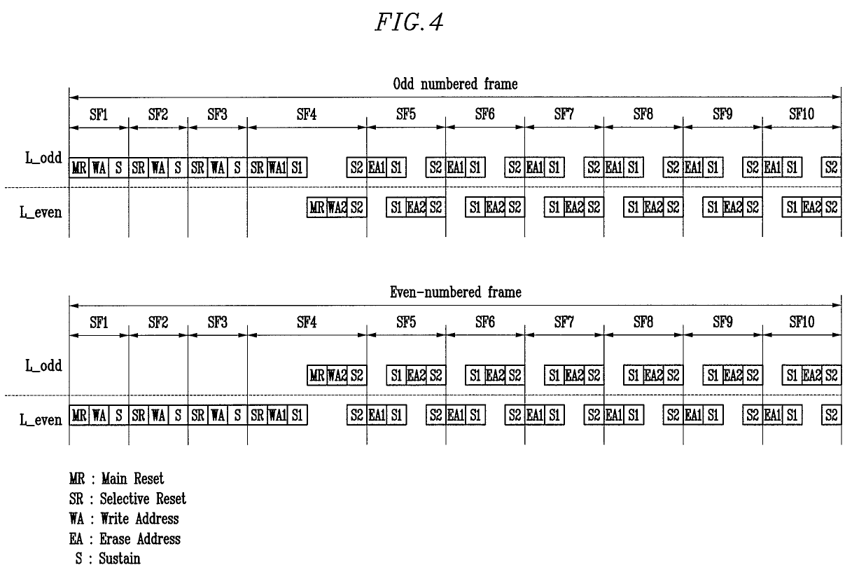

FIG. 4 shows a driving method of the plasma display device according to the first and second exemplary embodiments of the present invention. It is illustrated in FIG. 4 that the first display regions are referred to as “L_odd” and the second display regions are referred to as “L_even”. As explained above, the first display regions are defined by the odd-numbered X electrodes X_odd and the Y electrodes Y1 to Yn, and the second display regions are defined by the even-numbered X electrodes X_even and the Y electrodes Y1 to Yn. A discharge cell in the on-state and having an amount of wall charges that is sufficient to generate a sustain discharge when a sustain discharge pulse is applied thereto will be referred to as an “on-cell” (or a “light emitting cell”), and a discharge cell in the off-state and having an amount of wall charges that is not sufficient to generate the sustain discharge when the sustain discharge pulse is applied thereto will be referred to as an “off-cell” (or a “non-light emitting cell”). A reset period in which all of the discharge cells whether or not they have undergone sustain-discharging in a previous subfield are initialized into a non-light emitting state is referred to as a “main reset period” (MR), and a reset period for reset-discharging only those cells that have undergone sustain-discharging in a previous subfield such that only those cells are initialized into the non-light emitting state is referred to as a “selective reset period” (SR). An address period in which wall charges are formed by address discharging cells in the non-light emitting state and thus the cells in the non-light emitting state are selected to be set or converted to the light-emitting state is referred to as a “write address period” (WA), and an address period in which wall charges are erased by address discharging cells in the light emitting state and thus the cells in the light emitting state are selected to be set or converted to the non-light emitting state is referred to as an “erase address period” (EA). In addition, a sustain period in which cells in the light emitting state are sustain discharged is referred to as “S”. In the following description, an address discharge that forms wall charges in the WA will be referred to as a “write discharge”, and an address discharge that erases wall charges in the EA will be referred to as an “erase discharge”.

As shown in FIG. 4, frames are divided into odd-numbered frames and even-numbered frames. In one embodiment, the frames may be divided into two groups, one of the two groups may include one or more frames, and the other may include one or more other frames. In one embodiment, the even-numbered frames and the odd-numbered frames are driven in different ways. Each frame is divided into a plurality of subfields SF1 to SF10 and driven. Here, the subfields SF1 to SF10 each have weights (which may be predetermined) for representing gray levels. For example, in one embodiment, respective weights of the subfields SF1 to SF10 can be set to 1, 2, 4, 8, 8, 8, 8, 8, 8, and 8.

In FIG. 4, in the first to third subfields SF1 to SF3 in the odd-numbered frame, the plurality of first display regions L_odd are driven, and the plurality of second display regions L_even are not driven. In the first to third subfields SF1 to SF3 in the even-numbered frame, the plurality of second display regions L_even are driven, and the plurality of first display regions L_odd are not driven. That is, the first and second display regions L_odd and L_even in the first to third subfields SF1 to SF3 are driven according to a two frame cycle, i.e., each of the display regions L_odd and L_even is driven every other frame during the first to third subfields SF1 to SF3.

The first subfield SF1 in the odd-numbered frame includes a main reset period MR, a write address period WA, and a sustain period S for the first display regions L_odd, and the second and third subfields SF2 and SF3 in the odd-numbered frame each include a selective-reset period SR, a write address period WA, and a sustain period S for the first display regions L_odd. The first subfield SF1 of the even-numbered frame includes a main reset period MR, a write address period WA, and a sustain period S for the second display regions L_even, and the second and third subfields SF2 and SF3 of the even-numbered frame each include a selective-reset period SR, a write address period WA, and a sustain period S for the second display regions L_even. Here, the second and third subfields SF2 and SF3 include the selective-reset period SR such that the respective reset periods may be shortened and a contrast ratio may be increased. In one embodiment, the second and third subfields SF2 and SF3 may include a main reset period MR instead of the selective-reset period SR.

In the fourth subfield SF4 of the odd-numbered frame, operations of the selective-reset period SR, a first write address period WA1, and a first sustain period S1 are performed on the plurality of first display regions L_odd, and subsequently, the plurality of second display regions L_even undergo the main reset period MR, a second write address period WA2, and the sustain period S2. That is, since the second display regions L_even during the first to third subfields SF1 to SF3 in the odd-numbered frame do not undergo any operations, the second display regions L_even during the fourth subfield SF4 in the odd-numbered frame undergo the main reset period MR. In addition, in the fourth to tenth subfields SF4 to SF10 in the odd-numbered frame, when a sustain discharge is generated for the second display regions L_even during the second sustain period S2, the sustain discharge is generated again for the first display regions L_odd.

In the fourth subfield SF4 of the even-numbered frame, operations of the selective-reset period SR, the first write address period WA1, and the sustain period S1 are performed on the second display regions L_even, and operations of an MR period, the second write address period WA2, and the second sustain period S2 are subsequently performed on the first display regions L_odd. Since the first display regions L_odd do not undergo any operations in the first to third subfields SF1 to SF3 in the even-numbered frame, the plurality of first display regions L_odd in the fourth subfield SF4 in the even-numbered frame undergo the main reset period MR. In addition, when a sustain discharge is generated for the first display regions L_odd during the second sustain period S2, the sustain discharge is generated again for the second display regions L_even.

Subsequently, the first display regions L_odd during the fifth to tenth subfields SF5 to SF10 in the odd-numbered frame undergo a first erase address period EA1 and the first sustain period S1. In addition, while operations of the S1 period are performed on the first display regions L_odd, the second display lines L_even undergo the first sustain period S1. Subsequent to the first sustain period S1, operations of a second erase address period EA2 and the second sustain period S2 are performed on the second display regions L_even. While operations of the second sustain period S2 are performed on the second display regions L_even, the first display regions L_odd undergo the second sustain period S2.

In the fifth subfield SF5 to the tenth subfield SF10 of the even-numbered frame, operations of the first erase address period EA1 and the first sustain period S1 are performed on the second display regions L_even. When the second display regions L_even undergo the first sustain period S1, the first display regions L_odd also undergo the first sustain period S1. Subsequent to the first sustain period S1, operations of the second erase address period EA2 and the second sustain period S2 are performed on the first display regions L_odd. When the first display regions L_odd undergo the second sustain period S2, the second display regions L_even also undergo the second sustain period S2.

As described, a driving method of the odd-numbered frame is substantially the same as a driving method of the even-numbered frame, except that the first display regions L_odd and the second display regions L_even in the odd-numbered frame are driven in a reverse (or swapped) order as compared to the first display regions L_odd and the second display regions L_even in the even-numbered frame according to the exemplary embodiment of the present invention. Hereinafter, a driving waveform of the odd-numbered frame will be described in more detail.

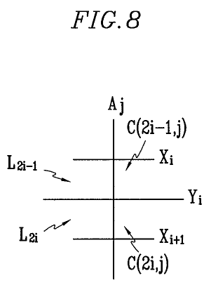

FIG. 5 shows a driving waveform of the first to third subfields SF1 to SF3 of the plasma display device, and FIG. 6 shows a driving waveform of the fourth subfield SF4 of the plasma display device. In addition, FIG. 7 shows a driving waveform of the fifth subfield SF5 of the plasma display device, and FIG. 8 shows a discharge cell defined by a first display region, a second display region, and an A electrode. In FIG. 5 to FIG. 7, driving waveforms applied to an Xi electrode among the plurality of X electrodes in the first group, an X(i+1) electrode among the plurality of X electrodes in the second group, a Yi electrode among the plurality of Y electrodes, and an Aj electrode among the plurality of A electrodes are illustrated for ease of description. Here, a first display region L(2i−1) is defined by the Xi electrode and the Yi electrode, and a second display region L(2i) is defined by the Yi electrode and the X(i+1) electrode (see, for example, FIG. 8). In addition, as shown in FIG. 8, a discharge cell C(2i−1, j) is defined by the first display region L(2i−1) and the Aj electrode, and a discharge cell C(2i, j) is defined by the second display region L(2i) and the Aj electrode.

As shown in FIG. 5, the main reset period MR of the first subfield SF1 includes an erase period I, a rising period II, and a falling period III.

During the erase period I of the main reset period MR, a voltage at the Yi electrode is gradually decreased from a Vs voltage to a reference voltage (0V in FIG. 5) while a voltage Ve is applied to the Xi and X(i+1) electrodes. Before the erase period I, i.e., in a sustain period of a last subfield of the previous frame, positive (+) wall charges were formed on the Xi and X(i+1) electrodes, and negative (−) wall charges were formed on the Yi electrode. These wall charges are substantially erased during the erase period I in the described embodiment.

Subsequently, in the rising period II of the main reset period MR, the voltage at the Yi electrode is gradually increased from the Vs voltage to a Vset voltage while the Aj electrode is applied with the reference voltage 0V, the X(i+1) electrode is applied with the Ve voltage, and the Xi electrode is applied with the reference voltage 0V. A weak discharge is generated between the Yi electrode and the Xi electrode and between the Yi electrode and the Aj electrode while the voltage at the Yi electrode is increased such that negative (−) wall charges are formed on the Yi electrode and positive (+) wall charges are formed on the Xi and Aj electrodes. Here, a reset discharge is not generated between the X(i+1) electrode and the Yi electrode since the X(i+1) electrode is applied with the Ve voltage. In addition, when the voltage at the Yi electrode is gradually changed (i.e., increased) as shown in FIG. 5, while a weak discharge is generated in the discharge cell, wall charges are formed such that a sum of an external voltage and a wall voltage can be maintained at a discharge firing voltage. In addition, the Vset voltage may be high enough to generate a discharge in cells in every condition since all cells in the first display regions Lodd are initialized during the main reset period MR of the first subfield SF1. The Vs voltage may be lower than a discharge firing voltage between the Y electrode and the X electrode.

During the falling period III of the main reset period MR, the voltage at the Yi electrode is gradually decreased from the Vs voltage to a voltage Vnf while the reference voltage 0V is applied to the Aj electrode and to the X(i+1) electrode, and the Ve voltage is applied to the Xi electrode. A weak discharge is generated between the Yi electrode and the Xi electrode and between the Yi electrode and the Aj electrode while the voltage of the Yi electrode is decreased such that the negative wall charges formed on the Yi electrode and the positive wall charges formed on the Xi electrode and the Aj electrode are erased and the discharge cell C(2i−1, j) is initialized. Here, since the X(i+1) electrode is applied with the reference voltage 0V, a discharge is not generated between the X(i+1) electrode and the Yi electrode. In general, when the Vnf voltage is applied to the Yi electrode during the falling period III of the main reset period MR, a sum of a wall voltage between the Xi electrode and the Yi electrode and an external voltage (Ve-Vnf) between the Xi electrode and the Yi electrode is set to be a discharge firing voltage. As such, the wall voltage between the Xi electrode and the Yi electrode may almost reach 0V such that a misfiring in a cell that is not address discharged during the write address period may be prevented during the sustain period. In addition, since the voltage at the Aj electrode is maintained at the reference voltage 0V, the wall voltage between the Yi electrode and the Aj electrode is determined by the Vnf voltage.

Subsequently, during the write address period WA of the first subfield SF1, a scan voltage VscL is applied to the Yi electrode while the X(i+1) electrode is applied with the reference voltage 0V and the Xi electrode is applied with the Ve voltage. Here, the VscL voltage may be set equal to or less than the Vnf voltage. In addition, an address voltage Va is applied to the Aj electrode that passes through discharge cells to be selected from the first display region L(2i−1) defined by the Yi electrode and the Xi electrode. A scan pulse having the VscL voltage is sequentially applied to the Y electrodes Y1 to Yn, and a Y electrode that is not applied with the VscL voltage is applied with a VscH voltage that is greater than the VscL voltage. An A electrode corresponding to an unselected discharge cell is applied with the reference voltage. Accordingly, a write discharge is generated in the discharge cell C(2i−1, j) such that positive wall charges are formed on a Y electrode adjacent to the Xi electrode and negative wall charges are formed on the Xi electrode.

It was illustrated in FIG. 3 that a scan pulse and an address pulse are respectively applied to one (of the Y electrodes (i.e., the Yi electrode) and one of the A electrodes (i.e., the Aj electrode) during the write address period WA. However, in general, the scan electrode driver 400 selects a Y electrode to which the scan pulse is applied from among the Y electrodes Y1 to Yn during the write address period WA. For example, vertically arranged Y electrodes may be sequentially selected in a single driving algorithm. When one of the Y electrodes is selected, the address electrode driver 300 selects discharge off-cells among discharge cells defined by the selected Y electrode. That is, the address electrode driver 300 selects a discharge cell to which an address pulse having the Va voltage is applied from among the A electrodes A1 to Am.

During the sustain period S of the first subfield SF1, sustain discharge pulses each alternately having a high level voltage (the Vs voltage in FIG. 5) and a low level voltage (the reference voltage 0V in FIG. 5) are applied to the Yi electrode and the Xi and X(i+1) electrodes such that the discharge cell C(2i−1, j) is discharged. Here, the sustain discharge pulse applied to the Yi electrode has a reverse phase of the sustain discharge pulse applied to the Xi and X(i+1) electrodes.

That is, when the Vs voltage is applied to the Yi electrode, the reference voltage 0V is applied to the Xi and X(i+1) electrodes, and when the Vs voltage is applied to the Xi and X(i+1) electrodes, the reference voltage 0V is applied to the Yi electrode. A sustain discharge is generated between the Yi electrode and the Xi electrode due to the Vs voltage and a wall voltage formed between the Yi electrode and the Xi electrode due to a write discharge during the write address period WA. Application of the respective sustain discharge pulses to the Yi electrode and the Xi and X(i+1) electrodes is repeated a number of times corresponding to a weight of the corresponding subfield.

Operations of a write address period WA and a sustain period S of the second and third subfields SF2 and SF3 are substantially the same as those of the first subfield SF1, except for the driving waveforms applied for the selective reset period SR and the number of sustain pulses applied for the sustain period S. Therefore, operations of the selective-reset period SR will be described in more detail.

The selective-reset period SR of the second and third subfields SF2 and SF3 has only a falling period III and not a rising period II, unlike the main reset period MR. That is, the Vs voltage is applied to the Yi electrode and the reference voltage 0V is applied to the Xi and X(i+1) electrodes such that the discharge cell C(2i−1, j) sustain-discharged in the previous subfield is reset-discharged to be set to an off-cell, and accordingly, positive wall charges and negative wall charges are respectively formed on the Xi electrode and the Yi electrode. The voltage at the Yi electrode is gradually decreased from the Vs voltage to the Vnf voltage while the Aj electrode is applied with the reference voltage 0V, the X(i+1) electrode is applied with the reference voltage 0V, and the Xi electrode is applied with the Ve voltage during the selective-reset period SR of the second and third subfields SF2 and SF3. As the voltage at the Yi electrode is decreased, a weak discharge is generated in discharge cells between the Yi electrode and the Xi electrode and between the Yi electrode and the Aj electrode, and thus the positive wall charges formed on the Aj electrode and the negative wall charges formed on the Yi electrode are substantially erased and the discharge cell C(2i−1, j) is initialized. Here, the discharge cells in which the weak discharge is generated are discharge cells that have undergone a sustain discharge in a previous subfield, that is, the first subfield SF1. Since discharge cells that have not undergone the sustain discharge in the first subfield SF1 among the discharge cells defined by the plurality of first display regions maintain the wall charge state after the end of the main reset period MR of the first subfield SF1, the discharge cells formed by the first display regions become non-light emitting cells after the selective-reset period SR of the second and third subfields SF2 and SF3.

As described above, in the first to third subfields SF1 to SF3 of the odd-numbered frame, operations of the reset period, the write address period, and the sustain period are performed only on the discharge cells defined by the first display regions.

In the first to third subfields SF1 to SF3 of the even-numbered frame, operations of the reset period, the write address period, and the sustain period are performed only on the discharge cells defined by the second display regions. Operations of the first to third subfields of the even-numbered frame are substantially the same as those of the first to third subfields SF1 to SF3 of the odd-numbered frame, and the driving waveform applied to the Xi electrode in the first to third subfields SF1 to SF3 of the odd-numbered frame is applied to the X(i+1) electrode in the first to third subfields SF1 to SF3 of the even-numbered frame. Similarly, the driving waveform applied to the X(i+1) electrode in the first to third subfields SF1 to SF3 of the odd-numbered frame is applied to the Xi electrode in the first to third subfields SF1 to SF3 of the even-numbered frame.

Subsequently, operations of a selective-reset period SR, a first write address period WA1, and a first sustain period S1 are performed on the plurality of first display regions L(2i−1) in the fourth subfield SF4, as shown in FIG. 6. Here, driving waveforms of the selective-reset period SR, the first write address period WA1, and the first sustain period S1 are substantially the same as those in the second and third subfields SF2 and SF3, except for the number of the sustain pulses applied for the first sustain period S1 which is determined by the weight of the corresponding subfield. Then, operations of a main reset period MR, a correction period AS, a second write address period WA2, and a second sustain period S2 are sequentially performed on the second display regions in the fourth subfield SF4. Here, except for the main reset period MR and the correction period AS, driving waveforms of the second write address period WA2 and the second sustain period S2 are substantially the same as those of the write address period WA and the sustain period S of the first subfield SF1. Therefore, only the main reset period MR and the correction period AS will be described in more detail below.

Unlike in the first subfield SF1, in a rising period II of the main reset period MR in the fourth subfield SF4, the reference voltage 0V is applied to the Aj electrode, the Ve voltage is applied to the Xi electrode, and the reference voltage 0V is applied to the X(i+1) electrode while the voltage at the Yi electrode is gradually increased from the Vs voltage to the Vset voltage. A weak discharge is generated between the Yi electrode and the X(i+1) electrode and between the Yi electrode and the Aj electrode while the voltage at the Yi electrode is increased such that negative wall charges are formed on the Yi electrode and positive wall charges are formed on the X(i+1) electrode and the Aj electrode. Here, since the Xi electrode is applied with the Ve voltage, no discharge is generated between the Xi electrode and the Yi electrode.

During a falling period III of the main reset period MR in the fourth subfield SF4, the voltage at the Yi electrode is gradually decreased from the Vs voltage to the Vnf voltage while the Aj electrode is applied with the reference voltage 0V, the Xi electrode is applied with the reference voltage 0V, and the X(i+1) electrode is applied with the Ve voltage. A weak discharge is generated between the Yi electrode and the X(i+1) electrode and between the Yi electrode and the Aj electrode while the voltage of the Yi electrode is decreased such that the negative wall charges formed on the Yi electrode and the positive wall charges formed on the X(i+1) electrode and the Aj electrode are substantially erased and the discharge cells C(2i, j) are thereby initialized. Here, since the Xi electrode is applied with the reference voltage 0V, no discharge is generated between the Xi electrode and the Yi electrode. As described above, the discharge cell C(2i, j) defined by the second display regions is initialized to be a non-light emitting cell in the main reset period MR of the fourth subfield SF4.

During the first sustain period S1 of the fourth subfield SF4, the Vs voltage is applied to the Yi electrode and the reference voltage 0V is applied to the Xi and X(i+1) electrodes and thus the last sustain discharge is generated in the discharge cells C(2i, j), and negative wall charges are formed on the Yi electrode and positive wall charges are formed on the Xi electrode. During the main reset period MR of the fourth subfield SF4, the discharge cells C(2i, j) defined by only the second display regions are initialized, and therefore a wall charge state of the Yi electrode and the Xi electrode is substantially the same as a wall charge state after the sustain period S of the third subfield SF3. In such a wall charge state, the Ve voltage is applied to the Xi electrode while the scan voltage is applied to the Yi electrode during the second write address period WA2, and accordingly, a wall voltage formed by wall charges formed during the first sustain period S1 and an external voltage of the first write address period WA1 may cause the discharge cells C(2i, j) to be discharged.

The correction period AS is provided to apply the reference voltage 0V to the Yi electrode while the Xi and X(i+1) electrodes are applied with the Ve voltage. A wall voltage is formed by the wall charges formed on the Yi electrode and the Xi electrode after the first sustain period S1 and the Ve voltage generates a discharge between the Yi electrode and the Xi electrode such that positive wall charges are formed on the Yi electrode and negative wall charges are formed on the Xi electrode. Since the discharge cells defined by the second display regions are initialized during the main reset period MR, no discharge is generated during the correction period AS, and therefore, the wall charge state of the discharge cells defined by the second display regions is substantially the same as the wall charge state after the main reset period MR.

Subsequently, during the second write address period WA2, a scan voltage (i.e., the VscL voltage) is sequentially applied to the Y electrodes while the Ve voltage is applied to the Xi and X(i+1) electrodes. Here, the VscL voltage may be set equal to or less than the Vnf voltage. An Aj electrode that passes through discharge on-cells among the discharge cells defined by the second display region L(2i) formed by the Yi electrode and the Aj electrode is applied with a voltage Va. A Y electrode to which the VscL voltage is not applied is applied with a VscH voltage that is greater than the VscL voltage and an A electrode corresponding to discharge off-cells is applied with the reference voltage. A write discharge is generated in the discharge cells C(2i, j) and thus positive wall charges are formed on the Yi electrode that is adjacent to the X(i+1) electrode and negative wall charges are formed on the X(i+1) electrode. In addition, since the negative wall charges and the positive wall charges are respectively formed on the Yi electrode and the Xi electrode that have undergone the discharge during the correction period AS, no write discharge is generated during the second write address period WA2.

Operations of the second sustain period S2 are substantially the same as that of the first sustain period S1 except that light emitting cells C(2i−1, j) and C(2i, j) undergo a sustain discharge. That is, cells that have undergone the write discharge during the second write address period WA2 among the discharge cells defined by the second display regions and cells that have undergone the sustain discharge during the first sustain period S1 among the discharge cells defined by the first display regions are in the light emitting state, and therefore, the cells in the light emitting state are sustain discharged.

Subsequently, a scan voltage VscL′ is applied to the Yi electrode while the reference voltage 0V is applied to the Xi and X(i+1) electrodes during a first erase address period EA1 of the fifth subfield SF5, as shown in FIG. 7. An Aj electrode that passes through on-cells among the discharge cells corresponding to the display region L(2i−1) defined by the Yi electrode (to which the VscL′ voltage is applied) and the Aj electrode is applied with an address voltage Va′. A Y electrode to which the VscL′ voltage is not applied is applied with a VscH′ voltage that is greater than the VscL′ voltage, and an A electrode passing through discharge off-cells is applied with the reference voltage. Accordingly, an erase discharge is generated in the discharge cells C(2i−1, j) and thus the wall charges formed on a Y electrode adjacent to an odd-numbered X electrode Xodd and the odd-numbered X electrode are substantially erased.

Here, the Vs voltage is applied to the X(i+1) electrode and the reference voltage 0V is applied to the Xi electrode while the Vs voltage is applied to the Yi electrode during a period S21 of the second sustain period S2 of the fourth subfield SF4, which is immediately previous to the fifth subfield SF5, such that only non-light emitting discharge cells among the discharge cells C(2i−1, j) formed by the first display region L(2i−1) are substantially erased during the first erase address period EA1. A sustain discharge is generated between the Yi electrode and the Xi electrode, and thus negative wall charges are formed on the Yi electrode adjacent to the Xi electrode and positive wall charges are formed on the Xi electrode. Since no sustain discharge is generated between the Yi electrode and the X(i+1) electrode, positive wall charges are formed on the Yi electrode adjacent to the X(i+1) electrode and negative wall charges are formed on the X(i+1) electrode. Accordingly, an erase discharge is generated only between the Xi electrode and the Yi electrode during the first erase address period EA1.

While the first sustain period S1 of the fifth subfield SF5 is similar to the first sustain period S1 of the fourth subfield SF4, during the first sustain period S1 of the fifth subfield SF5, cells that have not undergone the erase discharge during the first erase address period EA1 and cells that have undergone the sustain discharge during the second sustain period S2 of the fourth subfield SF4 are light emitting cells, and therefore cells that have not undergone the erase discharge during the first erase address period EA1 among light emitting cells defined by the first display regions L(2i−1) and cells that have undergone the sustain discharge during the second sustain period S2 of the fourth subfield SF4 among discharge cells defined by the second display regions L(2i) are concurrently sustain discharged.

Operations of the second erase address period EA2 of the fifth subfield SF5 are substantially the same as those of the first erase address period EA1 of the fourth subfield SF4. However, an erase discharge is generated in turn-off cells among the light emitting cells defined by the second display regions L(2i) during the first erase address period EA1, and therefore the wall charges formed on the Yi electrode adjacent to the X(i+1) electrode and the X(i+1) electrode are erased. As described above, the erase discharge can be generated in only non-light emitting cells C(2i, j) among the light emitting cells defined by the second display regions L(2i) during the second erase address period EA2 by applying the Vs voltage to the Xi electrode and the reference voltage 0V to the X(i+1) electrode while the Vs voltage is applied to the Yi electrode during a period S11 of the first sustain period S1, which is immediately previous to the second erase address period EA2. Then, a sustain discharge is generated only between the Yi electrode and the X(i+1) electrode, and thus negative wall charges are formed on the Yi electrode adjacent to the X(i+1) electrode and negative wall charges are formed on the X(i+1) electrode. Since no sustain discharge is generated between the Yi electrode and the Xi electrode, positive wall charges are formed on the Yi electrode adjacent to the Xi electrode and negative wall charges are formed on the Xi electrode. Accordingly, the erase discharge is generated only between the X(i+1) electrode and the Yi electrode during the second erase address period EA2.

During the second sustain period S2, cells that have not undergone the erase discharge during the erase address periods EA1 and EA2 become light emitting cells, and therefore, cells that have not undergone the erase discharge during the erase address periods EA1 and EA2 among light emitting cells defined by the first and second display regions L(2i−1) and L(2i) are concurrently sustain discharged.

Driving waveforms applied to the respective electrodes in the sixth to tenth subfields SF6 to SF10 are substantially the same as the driving waveforms applied to the respective electrodes in the fifth subfield SF5.

As described above, the wall charge state of the discharge cells C(2i−1) and C(2i) defined by the first and second display regions L(2i−1) and L(2i) can be controlled during the second sustain period S2 previous to the first erase address period EA1 and the first sustain period S1 previous to the second erase address period EA2 in the first to tenth subfields SF5 to SF10, and therefore, the wall charge state of the discharge cells C(2i−1) and C(2i) defined by the first and second display regions L(2i−1) and L(2i) can be differently controlled even if a same voltage is applied to the Xi electrode and the X(i+1) electrode during the erase address periods EA1 and EA2.

According to the exemplary embodiments of the present invention, a scan line can be formed of two Y electrodes among the plurality of Y electrodes or one of the Y electrodes, but each of the Y electrodes defines two display lines. Therefore, the number of scan circuits can be reduced compared to a structure wherein only one display region is defined by one X electrode and one Y electrode.

While the invention has been described in connection with certain exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A method for driving a plasma display device during a plurality of subfields of a frame, the plasma display device comprising a plurality of scan lines and a plurality of address lines crossing the scan lines, the scan lines corresponding to first display regions and second display regions, and further comprising a plurality of first discharge cells defined by the first display regions and the address lines, and a plurality of second discharge cells defined by the second display regions and the address lines, the method comprising:
selecting a first non-light emitting cell from among a plurality of first light emitting cells of the plurality of first discharge cells during a first address period of a first subfield among the plurality of subfields;
selecting a second non-light emitting cell from among a plurality of second light emitting cells of the plurality of second discharge cells during a second address period of the first subfield;
sustain-discharging only the plurality of first light emitting cells during a first period immediately previous to the first address period; and
sustain-discharging only the plurality of second light emitting cells during a second period immediately previous to the second address period.

2. The driving method of claim 1, further comprising:
sustain-discharging the first light emitting cells and the second light emitting cells during a third period immediately previous to the first period; and
sustain-discharging the first light emitting cells, except for the first non-light emitting cell, and the second light emitting cells, except for the second non-light emitting cell, during a fourth period immediately previous to the second period.

3. The driving method of claim 2, wherein the plasma display device further comprises:
a plurality of scan electrodes forming the plurality of scan lines; and
a plurality of sustain electrodes corresponding to the plurality of scan electrodes,
wherein the plurality of first display regions are defined by a first group of the plurality of sustain electrodes and the plurality of scan electrodes, and the plurality of second display regions are defined by a second group of the plurality of sustain electrodes and the plurality of scan electrodes.

4. The driving method of claim 2, wherein the plasma display device further comprises:
a plurality of scan electrodes forming the plurality of scan lines; and
a plurality of sustain electrodes corresponding to the plurality of scan electrodes,
wherein each of the scan electrodes is categorized into one of a first scan electrode group or a second scan electrode group,
wherein each of the sustain electrodes is categorized into a first sustain electrode group or a second sustain electrode group,
wherein the first display regions are defined by the scan electrodes of the first scan electrode group and the sustain electrodes of the first sustain electrode group, and the second display regions are defined by the scan electrodes of the second scan electrode group and the sustain electrodes of the second sustain electrode group, and
wherein each of the scan lines is formed by one of the scan electrodes of the first scan electrode group and one of the scan electrodes of the second scan electrode group.

5. The driving method of claim 4, wherein the driving method further comprises:
during the first period,
applying a first low level voltage and a first high level voltage to the plurality of sustain electrodes of the first sustain electrode group and the sustain electrodes of the second sustain electrode group, and applying a second high level voltage to the scan electrodes; and
during the second period,
applying the first high level voltage to the plurality of sustain electrodes of the first sustain electrode group and the plurality of sustain electrodes of the second sustain electrode group, and applying the second high level voltage to the scan electrodes.

6. The driving method of claim 5, wherein the driving method further comprises:
during each of the third and the fourth periods,
applying at least one cycle of a first sustain discharge pulse alternately having the second high level voltage and a second low level voltage to the scan electrodes, and applying at least one cycle of a second sustain discharge pulse alternately having the first high level voltage and the first low level voltage to the plurality of sustain electrodes, the second sustain discharge pulse having a reverse phase of the first sustain discharge pulse,
the third and fourth periods being terminated after the second low level voltage is applied to each of the plurality of scan electrodes.

7. The driving method of claim 5, further comprising:
during the first address period,
applying a first voltage and a second voltage respectively to a scan electrode of the scan electrodes and an address line of the address lines corresponding to the first non-light emitting cell concurrently with applying the first voltage to the plurality of sustain electrodes; and
during the second address period,
applying the first voltage and the second voltage respectively to a scan electrode of the scan electrodes and an address line of the address lines corresponding to the second non-light emitting cell concurrently with applying the first voltage to the plurality of sustain electrodes.

8. The driving method of claim 5, wherein the first and third periods correspond to a subfield of the subfields previous to the first subfield.

9. The driving method of claim 5, further comprising setting the plurality of first discharge cells and the plurality of second discharge cells respectively as the plurality of first light emitting cells and the second light emitting cells of a period previous to the first address period.

10. A method for driving a plasma display device during a plurality of subfields of a frame, the plasma display device including a plurality of scan electrodes forming a plurality of scan lines, a plurality of sustain electrodes corresponding to the plurality of scan electrodes, a plurality of display regions defined by the scan electrodes and the sustain electrodes, a plurality of address electrodes crossing the display regions, and a plurality of discharge cells formed at crossing regions of the display regions and the address electrodes, the method comprising:
during a first period of a first sustain period of a first subfield among the plurality of subfields, applying a first voltage and a second voltage higher than the first voltage respectively to a sustain electrode of a first sustain electrode group of the plurality of sustain electrodes and a sustain electrode of a second sustain electrode group of the plurality of sustain electrodes, and applying a third voltage higher than the first voltage to the plurality of scan electrodes;
during a first address period of a second subfield among the plurality of subfields following the first period of the first sustain period, sequentially applying a first scan pulse to the plurality of scan lines concurrently with applying a fourth voltage to the sustain electrodes of the first and second sustain electrode groups;
during a second period of a second sustain period of the second subfield following the first address period, applying the second voltage and the first voltage respectively to the sustain electrodes of the first sustain electrode group and the sustain electrodes of the second sustain electrode group, and applying the third voltage to the plurality of scan electrodes; and
during a second address period of the second subfield following the second period of the second sustain period, sequentially applying a second scan pulse to the plurality of scan lines concurrently with applying the fourth voltage to the sustain electrodes of the first and second sustain electrode groups.

11. The driving method of claim 10, further comprising:
during each of the first sustain period and the second sustain period,
applying sustain discharge pulses each alternately having a fifth voltage and a sixth voltage lower than the fifth voltage to the plurality of scan electrodes and the plurality of sustain electrodes, the sustain discharge pulses applied to the scan electrodes having a reverse phase of the sustain discharge pulses applied to the sustain electrodes.

12. The driving method of claim 11, further comprising:
during each of the first address period and the second address period,
applying an address pulse to one of the address electrodes, the one of the address electrodes corresponding to a discharge cell to be set to a non-light emitting state among discharge cells of the discharge cells defined by the respective scan electrode to which the scan pulse is applied.

13. The driving method of claim 12, wherein the plurality of display regions comprises:
a plurality of first display regions respectively defined by one sustain electrode of the first sustain electrode group and one of the plurality of scan electrodes; and
a plurality of second display regions respectively defined by one sustain electrode of the second sustain electrode group and one of the plurality of scan electrodes.

14. The driving method of claim 12, wherein each of the plurality of scan electrodes is categorized in one of a first scan electrode group or a second scan electrode group,
wherein the plurality of display regions comprises:
a plurality of first display regions respectively defined by one scan electrode of the first scan electrode group and one sustain electrode of the first sustain electrode group; and
a plurality of second display regions respectively defined by one scan electrode of the second scan electrode group and one sustain electrode of the second sustain electrode group, and
wherein each of the display regions is defined by one scan electrode of the first scan electrode group or one scan electrode of the second scan electrode group.

15. A plasma display device comprising:
a plasma display panel (PDP) having a plurality of scan lines corresponding to a plurality of first display regions and a plurality of second display regions, a plurality of address lines crossing the scan lines, and a plurality of discharge cells defined by the first display regions, the second display regions, and the plurality of address lines; and
a driver adapted to,
in a first period of a first sustain period of a first subfield of subfields of a frame, sustain-discharge only a plurality of first light emitting cells defined by the plurality of first display regions,
in a first address period of a second subfield of the subfields following the first period of the first sustain period, select non-light emitting cells from the plurality of first light emitting cells,
in a second period of a second sustain period of the second subfield following the first address period, sustain-discharge a plurality of second light emitting cells defined by the plurality of second display regions, and
in a second address period of the second subfield following the second period of the second sustain period, select non-light emitting cells from the plurality of second light emitting cells.

16. The plasma display device of claim 15, wherein the PDP comprises:
a plurality of scan electrodes forming the plurality of scan lines; and
a plurality of sustain electrodes corresponding to the plurality of scan electrodes, each of the sustain electrodes being categorized in one of a first sustain electrode group or a second sustain electrode group, and
wherein the driver is further adapted to sequentially apply a scan pulse to the plurality of scan lines while biasing the plurality of sustain electrodes with a first voltage during the first and second address periods.

17. The plasma display device of claim 16, wherein the plurality of first display regions are defined by the sustain electrodes of the first sustain electrode group and the plurality of scan electrodes, and the plurality of second display regions are defined by the sustain electrodes of the second sustain electrode group and the plurality of scan electrodes.

18. The plasma display device of claim 16, wherein the plurality of first display regions are defined by the sustain electrodes of the first sustain electrode group and the scan electrodes of a first scan electrode group of the scan electrodes, and the plurality of second display regions are formed by the sustain electrodes of the second sustain electrode group and the scan electrodes of a second scan electrode group of the scan electrodes, and
wherein each of the scan lines is formed by one scan electrode of the first scan electrode group and one scan electrode of the second scan electrode group.

19. The plasma display device of claim 17, wherein the driver is further adapted to,
during the first period of the first sustain period, apply a first voltage to the sustain electrodes of the first sustain electrode group and a second voltage higher than the first voltage to the sustain electrodes of the second sustain electrode group and apply the second voltage to the plurality of scan electrodes, and
during the second period of the second sustain period, apply the second voltage to the sustain electrodes of the first sustain electrode group and the first voltage to the sustain electrodes of the second sustain electrode group and apply the second voltage to the plurality of scan electrodes.

20. The plasma display device of claim 19, wherein the driver is further adapted to,
during a third period previous to the first period of the first sustain period, apply the first voltage to the scan electrodes and the second voltage to the sustain electrodes and sustain-discharge the first and second light emitting cells, the first voltage applied to the scan electrodes having a reverse phase of the second voltage applied to the sustain electrodes, and
during a fourth period previous to the second period of the second sustain period, apply the first voltage to the scan electrodes and the second voltage to the sustain electrodes and sustain-discharge the first light emitting cells, except for the selected non-light emitting cells from the first light emitting cells, and the second light emitting cells, except for the selected non-light emitting cells from the second light emitting cells, the first voltage applied to the scan electrodes having a reverse phase of the second voltage applied to the sustain electrodes.
